(19) United States
(12) Patent Application Publication
(10) Pub. No.: US 2006/0240227 A1
(43) Pub. Date: Oct. 26, 2006

(54) Nanocrystal coated surfaces

(76) Inventors: Zhijun Zhang, Ottawa (CA); Catherine Smith, Gloucester (CA); Roy Walker, Navan (CA); Danial D. M. Wayner, Ottawa (CA)

Correspondence Address: GOWLING, LAFLEUR HENDERSON LLP, ONE MAIN STREET WEST, HAMILTON, ON, L8P 4Z5, CA

(21) Appl. No.: 11/232,013

(22) Filed: Sep. 22, 2005

Related U.S. Application Data
(60) Provisional application No. 60/612,168, filed on Sep. 23, 2004.

(51) Int. Cl. B32B 5/16; B05D 5/12; B05D 7/00

(52) U.S. Cl. 428/195.1; 428/323; 427/402; 427/126.1; 427/212

(57) ABSTRACT

The present invention provides novel calibration devices for use with fluorescent nanocrystal labels. Methods of preparing and using the calibration devices are also provided. Monodispersed populations of nanocrystals are deposited on surfaces. The monodispersed populations are obtained by dissolving the nanocrystals in a polar solvent.

### FIELD OF INVENTION

The present invention relates to methods and materials for the deposition and encapsulation of nanocrystals on surfaces.

### BACKGROUND OF THE INVENTION

Various types of detection systems are used to detect the presence of an analyte in a sample. Traditional methods often used radiolabeled probes. However, nonisotopic detection systems are increasingly preferred due to safety and disposal concerns associated with the use of radiolabels. An immunoassay, such as an ELISA (enzyme linked immunosorbent assay), can be used to detect the presence of an analyte using an enzyme labeled antibody.

Fluorescent molecules are also often used as tags on probes for detecting an analyte of interest. The analyte, sometimes referred to herein as the target, is detected using a probe that binds specifically to the target. Various types of target-probe interactions, such as protein-protein interactions, receptor-ligand interactions, antibody-antigen interactions, aptamer-protein interactions and interactions between complementary oligonucleotides, can be analyzed. The labeled probe-target type of assay can also be used to detect compounds that inhibit that interaction by comparing the signal obtained with a known amount of the target in the presence and absence of a candidate inhibitor compound.

While tagging of bio molecules or calibrating of the fluorescent scanner using organic dyes is a very useful and common practice in biological science, conventional organic fluorophores have significant limitations. They generally have narrow excitation profiles and broad emission bands which make simultaneous quantitative detection of different probes present in the same sample very difficult. Also, some organic fluorophores are easily bleached by repeated exposure to visible or ultraviolet light. Others decay with age even when kept in the dark. Moreover, variation of the absorption and/or emission spectra of the organic dye-tagged bio conjugates requires the use of chemically distinct molecular labels with attendant synthesis and conjugation challenges. The use of multiple dye labels makes the detection device very complicated and expensive.

To address the problems encountered when using organic fluorescent dyes, fluorescent nanocrystals are increasingly being used as fluorescent tags in bioassays. A nanocrystal is an inorganic crystallite between about 1 and 1000 nm in diameter. The term nanocrystal as used herein encompasses core nanocrystals, semiconductor nanocrystals and functionalized nanocrystals. The optical properties of nanocrystals are governed by strong quantum confinement effects and are therefore size dependent. Nanocrystals have good photo- and chemical stability and readily tunable spectral properties. With broad excitation and narrow emission profiles, they facilitate multicolour detection using a basic fluorescent scanner.

Recently high-throughput screening (HTS) systems have been developed to rapidly evaluate multiple candidate compounds. Fluorescent nanocrystal tagged molecules are used to detect a target of interest. For example, highly parallel detection of DNA hybridization using microarrays shows tremendous promise for medical, pharmaceutical, forensic, and other applications. The microarrays are typically 2D patterns comprising of an array of probe spots printed onto a glass microscope slide using a robotic spotter. Each probe spot contains DNA strands with a known DNA sequence. To identify the DNA contained in a test sample, the test sample is mixed with a fluorescent dye, and then spread over the array of probes on the microarray. Where DNA strands complementary to those in the test sample are found, the DNA in the test sample attaches itself to the known DNA in the probe spot. A fluorescent scanner or microscope is used to image the microarray, showing bright fluorescent spots wherever the DNA in the unknown sample has found a match in a probe spot.

Nanocrystals have been used as detectable labels in a variety of applications. For example, U.S. Pat. No. 6,630,307 describes the use of more than one nanocrystal to simultaneously detect multiple analytes. U.S. Pat. No. 6,828,142 discloses polynucleotide strands operably linked to water-soluble nanocrystals and the use of those molecules as molecular probes to detect target molecules. U.S. Pat. No. 6,855,551 describes the use of quantum dots (fluorescent semiconductor nanocrystals) to detect the presence, amount, localization, conformation or alteration of biological moieties. U.S. Pat. No. 6,890,764 discloses the encoding and decoding of array sensors using nanocrystals. The arrays can be used to detect the localization of a plurality of bioactive agents. United States Patent Application 2001/0055764 also describes microarray methods utilizing semiconductor nanocrystals. By controlling the size and composition of the nanocrystals, probes can be developed that emit at particular wavelengths. United States Patent Application 2002/0001716 discloses functionalized fluorescent nanocrystal that are encapsulated in a liposome. The liposome typically has an affinity molecule bound to it and can be used to detect the presence of a target molecule. United States Patent Application 2003/0099940 describes an assay where two or more differently colored quantum dots can be detected on a single target species such as nucleic acids, polypeptides, small organic bioactive agents and organisms. United States Patent Application 2004/0105973 discloses ultrasensitive nanocrystals that comprise a core and shell as well as a cap of water-solubilization agents. United States Patent Application 2004/0249227 describes a biosensor in the form of a microchip for detecting an analytes by time-resolved luminescence measurement. United States Patent Application 2005/0107478 describe a process for a solid composite comprising colloidal nanocrystals dispersed in a sol-gel matrix and suggest that these composites may be useful as phosphor materials for use in light emitting diodes and solid state lighting structures.

Fluorescent nanocrystals provide for a detectable label or tag that is stable and has high fluorescent intensity. Nanocrystals have proven useful as probe tags in a variety of biological and chemical assays. Yet, there remained a need for a convenient method to quantitate results and to provide consistency from one array to the next. There was also a need for methods and materials to easily calibrate fluorescence detectors.

### SUMMARY OF THE INVENTION

While nanocrystals have proven useful as fluorescent tags for probe molecules, previous attempts to prepare nanocrystal standards have not yielded consistent results. The present invention addresses the need for improved calibration devices and methods for microarray assays. The invention also provides methods and materials for quantifying binding reactions using microarrays on solid surfaces. Predetermined amounts of nanocrystals are deposited in spots on a solid surface and are used to calibrate fluorescence reading devices. The solid surface having the nanocrystals deposited thereon is preferably coated with a sol-gel film. A microarray binding assay is preferably, but not necessarily, done on the surface of the sol-gel film. Thus, a single surface comprising the nanocrystal standard and the sol-gel assay surface can be used for easier calibration of results.

In one embodiment of the invention, the nanocrystals (NCs) are designed to mimic the photophysical properties of organic dyes used in bio-analyses. These may include the cyanine dyes (e.g. Cy3 or Cy5) or any other commercial dye including Alexa 488 or Texas Red. Arrays of the core NCs are very stable against photo-oxidation and aging, compared with conventional organic dyes such as Cy3 and Cy5. In a preferred embodiment, core NCs are replaced by core/shell NCs. The present invention provides a new strategy for synthesis and arraying of CdSe/ZnS core/shell NCs with strong fluorescence and good monodispersity. The core/shell NCs provide a monodisperse population for the calibration standard.

In one aspect of the invention, a calibration device for a fluorescence detector is provided. The device comprises at least one deposit of essentially uniformly deposited nanocrystals.

In a preferred embodiment, the deposited nanocrystals form a spot having a diameter from about 1 to 1000 microns, preferably about 10 to 500 microns.

In the calibration device of the invention, the deposit preferably comprises at least one nanocrystal having a core selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN) and the like including mixtures of such materials.

In a preferred embodiment, the nanocrystals deposited on the calibration device further comprise a shell of a material other than that of the core wherein the shell material is selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN), mixtures thereof and the like.

In a preferred calibration device of the invention, the deposited nanocrystal is hydrophilic. In a particularly preferred embodiment, the nanocrystal comprises a CdSe core and a ZnS shell.

In a further preferred embodiment, the calibration device comprises a plurality of deposits in the form of spots. The nanocrystals may vary in size or number from one deposit to another. Preferably, the calibration device comprises a series of spots wherein the number of deposited nanocrystals increases throughout the series of spots.

In another aspect of the invention, the calibration device comprises at least one deposit of nanocrystals overlaid with a sol-gel film.

In yet another aspect of the invention, a process for preparing a layer of nanocrystals is provided. The process comprises:
i. preparing a solution of nanocrystals in a polar solvent;
ii. depositing the solution on a surface; and
iii. coating the surface with a sol-gel film.

In one preferred embodiment, the nanocrystal comprises a core selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN) and the like including mixtures of such materials.

In another preferred embodiment, the nanocrystal further comprises a shell of a material other than that of the core wherein the shell material is selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN), mixtures thereof and the like.

In another preferred embodiment, the nanocrystal comprises a CdSe core. In a further preferred embodiment, the nanocrystal comprises a ZnS shell.

In another embodiment, the nanocrystal comprises a core of a metallic material wherein the metallic material is selected from the group consisting of gold (Au), silver (Ag), cobalt (Co), iron (Fe), nickel (Ni), copper (Cu), manganese (Mn), alloys thereof and alloy combinations.

In another aspect of the invention, the nanocrystals are functionalized to be hydrophilic and are soluble in a polar solvent such as ethanol, methanol, propanol, butanol, glycol, ether, polyol, polyether, mixtures thereof and the like. One preferred solvent is ethylene glycol.

In a further aspect of the invention, the surface containing the nanocrystal is coated with a sol-gel film. The sol-gel film preferably comprises tetraethyl orthosilicate.

In another aspect of the invention a surface comprising at least one region of dispersed nanocrystals coated with a sol-gel film is provided. In a preferred embodiment, the surface comprises a microscope slide. In a further preferred embodiment, the surface comprises a plurality of regions of nanocrystals, wherein the density of nanocrystals varies from region to region. In another preferred embodiment, the microscope slide comprises at least two different types of nanocrystals.

In another aspect of the invention, a method of quantifying a binding reaction is provided. The method comprises:
i. providing an array of an immobilized ligand on the surface of a slide;
ii. contacting the array with a sample:
iii. detecting binding of the sample to the ligand using a nanocrystal detector;
iv. comparing the signal obtained by binding of the sample to the signal generated by a series of spots, each spot comprising a predetermined standardized homogenous dispersion of nanocrystals; and
v. determining the extent of binding based on the number of nanocrystals bound to the sample spot as compared to a standardized spot.

### BRIEF DESCRIPTION OF THE DRAWINGS

These and other features of the invention will become more apparent from the following description in which reference is made to the appended drawings wherein:

FIG. 1 is a schematic illustration for synthesis of hydrophilic CdSe core (a) and CdSe/ZnS core/shell (b) NCs wherein the dimensions of the core, shell, and surface ligand molecules are not to scale;

FIG. 2 illustrates the UV-vis spectra of CdSe core NCs growing from small to large size with time;

FIG. 3 illustrates the emission colors of the CdSe core NCs shown in FIG. 2 with diameters from 2.3 to 4.2 nm;

FIG. 4 illustrates the UV-vis absorption (blue) and fluorescence (red) spectra of CdSe core NCs (2.7 nm) in chloroform solution;

FIG. 5 is an AFM image of a cluster of CdSe NCs (3.3 nm);

FIG. 6 is a high resolution TEM image of CdSe NCs (3.0 nm);

FIG. 7 illustrates the UV-vis spectra of CdSe/ZnS core/shell NCs in chloroform and the water-soluble NCs in water;

FIG. 8 demonstrates the emission spectra of a chloroform solution of the as-prepared CdSe/ZnS core/shell NCs and an aqueous solution of the water-soluble NCs;

FIG. 9 illustrates the emission color of a chloroform solution of the as-prepared CdSe/ZnS core/shell NCs (left) and an aqueous solution of the water-soluble NCs (right);

FIG. 10 is a confocal image of arrays of the CdSe/ZnS NCs on a glass slide deposited from ethylene glycol-water (v/v 50/50%) solution;

FIG. 11 demonstrates the effect of aging on the CdSe/ZnS core/shell NCs and Cy3 arrayed on glass slides;

FIG. 12 illustrates NCs printed from 50 percent ethylene glycol in water;

FIG. 13 illustrates the stability of the fluorescence intensity over a long term period of storage;

FIG. 14 shows confocal images of arrays of the CdSe/ZnS core/shell NCs before (left) and after (right) a sol-gel overcoating was applied; and

FIG. 15 shows a hybridized DNA microarray with an NC standard array printed at the left edge wherein the microarray was hybridized with a mixture of labeled single strand DNA probes according to standard procedures.

### DETAILED DESCRIPTION

The present invention provides a novel type of calibration device. Methods of preparing calibration devices and standardized deposits that are useful for calibration of fluorescent reading devices are also provided. They are particularly useful for microarray assays that use nanocrystals as fluorescent tags to detect binding of a probe to a target. Colloidal semiconductor nanocrystals (NCs) are novel inorganic fluorophores developed in the past twenty years. Their optical properties are governed by strong quantum confinement effects, and therefore, are size dependent. These NCs have good photo- and chemical stability and readily tuneable spectral properties. By controlling the size and composition of the nanocrystals, tags having very specific excitation and emission wavelengths can be generated. Nanocrystal tags can be used to detect a single target or combinations of specific nanocrystals can be used to simultaneously detect multiple targets. The methods of the present invention can be used to provide standards for single or multiple detection assays.

As used herein, the terms “semiconductor nanocrystal”, “nanocrystal” and “NC” are used interchangeably to refer to an inorganic crystallite between about 1 nm and about 1000 nm in diameter that is capable of emitting electromagnetic radiation upon excitation. The luminescence emitted is generally within a narrow range of wavelength. The nanocrystals useful in the present invention generally comprise a “core” of one or more semiconductor materials, and may be surrounded by a “shell” of a different semiconductor material. The surrounding “shell” material will preferably have a bandgap energy that is larger than the bandgap energy of the core material and may be chosen to have an atomic spacing close to that of the “core” substrate. The core and/or the shell typically comprise a semiconductor material selected from the group II-VI (ZnS, ZnSe, ZnTe, CdS, CdSe, CdTe, HgS, HgSe, HgTe, MgS, MgSe, MgTe, CaS, CaSe, CaTe, SrS, SrSe, SrTe, BaS, BaSe, BaTe, and the like) and III-V (GaN, GaP, GaAs, GaSb, InN, InP, InAs. InSb, and the like) and IV (Ge, Si, and the like) materials, and an alloy or a mixture thereof.

The semiconductor nanocrystals of the present invention are preferably surrounded by a coat of an organic capping agent. The organic capping agent may be any number of materials, but has an affinity for the semiconductor nanocrystal surface. In the present invention, the coat promotes solubility particularly solubility in a polar solvent. The coat may also be selected to influence the optical properties of the nanocrystal.

In the present invention, the nanocrystals are provided as monodisperse particles. In a population of monodisperse particles, at least about 60% of the particles in the population, more preferably 75% to 90% of the particles in the population fall within a specified particle size range. A population of monodispersed particles deviate less than 10% rms (root-mean-square) in diameter and preferably less than 5% rms. Different populations of monodisperse particles may be used as distinct labels that can be individually detected.

In the present application, the phrase “one or more populations of nanocrystals” is used synonymously with the phrase “one or more particle size distributions of semiconductor nanocrystals.” One of ordinary skill in the art will realize that particular sizes of semiconductor nanocrystals are actually obtained as particle size distributions.

The term “target” is used herein to refer to an organic or inorganic molecule for which the presence or amount is being assayed in a sample. Examples of molecules that may be targets include, but are not limited to, a nucleic acid molecule, protein, glycoprotein, eukaryotic cell, prokaryotic cell, lipoprotein, peptide, carbohydrate, lipid, phospholipid, aminoglycans, chemical messenger, biological receptor, structural component, metabolic product, enzyme, antigen, drug, therapeutic, toxin, inorganic chemical, organic chemical, a substrate, and the like. The target includes a determinant such as an epitope, a domain, a sequence or the like that is specifically recognized by a molecular probe.

The term “probe” is used herein to refer to a molecule that has binding specificity and avidity for a molecular component of, or associated with, a target molecule. Some examples of probes include, but are not limited to, lectins or fragments or derivatives thereof which retain binding function, monoclonal antibodies, including chimeric or humanized monoclonal antibodies and fragments thereof, peptides, aptamers, and nucleic acid molecules including, but not limited to, single stranded RNA or single-stranded DNA, or single-stranded nucleic add hybrids, oligonucleotide analogs, backbone modified oligonucleotide analogs, and morpholino-based polymers.

Methods for producing monoclonal antibodies, fragments and derivatives thereof are well known in the art. Similarly, aptamers, lectins, oligonucleotides, peptides, etc. are easily obtainable using standard methods.

A semiconductor nanocrystal may be “linked” or “conjugated” to, or “associated” with, a specific-binding molecule referred to herein as a probe. The semiconductor nanocrystal may either be directly linked to the specific-binding molecule or it may be linked via a linker moiety, such as a chemical linker. Alternatively, the nanocrystal tag may be linked to a secondary binding partner that binds to the specific-binding molecule or probe. For example, nanocrystals can be associated with biotin which can bind to the proteins, avidin and streptavidin which may be associated with the specific probe. The nanocrystals can also be linked to secondary antibodies that bind to primary probe antibodies. In addition, nanocrystals can be associated with molecules that bind nonspecifically or sequence-specifically to nucleic acids such as DNA and RNA. Such molecules include small molecules that bind to the minor groove of DNA, small molecules that form adducts with DNA and RNA, molecules that intercalate between the base pairs of DNA, and metal complexes that bind and/or damage nucleic acids through oxidation to mention a few. This also includes complementary nucleic acids that hybridize specifically to target nucleic acid sequences.

As used herein, the term “functionalized nanocrystals” refers to fluorescent nanocrystals that are coated with at least one coating that either enhances stability and/or solubility or provides one or more reactive functionalities that may be used to operably link the functionalized nanocrystal to a plurality of polynucleotide strands, or to a linker or another type of probe. A coating typically comprises amino acid (e.g., the coating comprises a capping compound comprising an amino acid; or amino acid is an additional coating that coats (is operably linked to) a capping compound, wherein the capping compound is other than amino acid; or amino acid coats a capping compound wherein the capping compound comprises amino acid. The nanocrystals of the present invention are preferably functionalized to be soluble in a polar solvent.

The materials and methods of the present invention are useful as calibration aids for fluorescent detectors and for standardizing assays that detect binding of a probe to a target.

For effective applications of the NCs in nanodevices and biosciences high quality NCs are required. In one aspect, the invention provides an NC-based calibration standard. The standard preferably has the following characteristics:
a. desired particle size over large range;
b. narrow size distribution;
c. high crystallinity;
d. controllable surface chemical and physical properties;
e. high quantum yield in case of luminescent materials;
f. uniform intensity distribution from the edge to the center of the array element.

In the methods and devices of the present invention, nanocrystals having a diameter from about 1 to about 100 nanometers, preferably from about 1 to 10 nanometers, are used to prepare calibration devices. One type of calibration device according to the present invention comprises an array of spots, wherein each spot comprises a monodispersed population of nanocrystals deposited on a solid surface. The device is used for scanner calibration and detector gain setting and for slide-to-slide quantitative comparison of fluorescence intensity. The spots in the array may vary in the density of the deposit or in the composition of the nanocrystals.

In the present invention, the calibration device may comprise a spot pf free nanocrystals deposited on a surface or a spot of nanocrystals that are linked to or associated with a probe molecule deposited on the surface.

The procedure for deposition and encapsulation of the nanocrystals can be described briefly as follows. Nanocrystals are synthesized. Preferably, CdSe core nanocrystals, CdSe/ZnS core/shell nanocrystals or other III-V semiconductor core or core/shell nanocrystals having the general formula, MX where M=divalent metal such as Zn, Pb, Co, Mn; and X can be at least one of S, Se and Te are used. Nanocrystals that are useful in the invention typically have diameters from 1 to 100 nanometers, preferably 2 to 10 nanometers. There is preferably an exchange of surface ligand to render the nanocrystals hydrophilic. This can be done using methods described in the literature with minor modifications. (Chan et al. Science, Vol 95, 2016-2018 (1998); Mattoussi et al. J. Am. Chem. Soc., Vol 122, 12142-12150 (2000); Gerion et al., J. Phys. Chem. B. Vol 105, 8861-8871 (2001)).

A depositing solution is then prepared by dissolving the core nanocrystals in polar solvent (e.g. alcohols such as methanol, glycols, any other polyol, ethers, polyethers, and mixtures of polar solvents). In the case of the CdSe/ZnS core/shell nanocrystals, mixing ethylene glycol with an aqueous solution of the core/shell nanocrystals provides for a good depositing solution.

The surface modification by amino-terminated silane of the CdSe core nanocrystals results in good solubility of the nanocrystals in polar solvents such as methanol while still maintaining significant photoluminescence. In contrast, the fluorescence of the water-soluble nanocrystals prepared from as-prepared CdSe core nanocrystals is quenched or almost completely quenched. When arrayed on a surface and encapsulated by sol-gel, the fluorescent signal of these hydrophilic core nanocrystals still remains strong. Moreover, hybridization does not result in marked reduction of the fluorescence intensity.

Previous attempts to prepare nanocrystal standard spots resulted in an uneven distribution of particles leading to a donut like ring of nanocrystals. In the present invention, the use of ethylene glycol as a co-solvent for water-soluble CdSe/ZnS core/shell nanocrystals permits the deposition of high quality arrays of the nanocrystals on glass slides. The nanocrystals in each spot are homogeneously distributed and strongly fluorescent. This provides significant improvement over previously known methods. For example, when a buffer that is routinely used for preparation of arrays of Cy3 or Cy5 is used to deposit the core/shell nanocrystals, arrays formed on the glass slides are inhomogeneous distributed with a low fluorescent intensity. Drop casting of a sol-gel film on the top of the arrays of these core/shell nanocrystals did not result in significant reduction of the fluorescence intensity.

Arrays of the nanocrystals are then printed from the depositing solution using a commercial microarrayer. The nanocrystals are deposited in spots that typically have diameters from about 1 to 1000 microns, preferably from about 10 to 500 microns.

The spots of deposited nanocrystals can then be used as calibration or standard spots. The deposited nanocrystal form a calibration device. The calibration device of the present invention may be a separate surface or it may be incorporated into an assay surface. As used herein the term “device” refers to a stand-alone calibration chip or slide and also to a calibration deposit(s) that is integral with the assay platform. An array of nanocrystal spots can be used as a calibration bar for a microchip assay. The calibration devices of the present invention are particularly useful in DNA micro-array assays.

In certain situations, it may be desirable to use the same slides, having the standardized deposit spots, for a biological or chemical assay such as a hybridization reaction. In this case, a sol-gel film is layered over the calibration spots. One the sol-gel film has hardened, an array of probes or targets can be imprinted on the surface using conventional methods. In one preferred embodiment, the sol-gel film is prepared from a sol consisting of tetraethyl orthosilicate, ethanol, water, and trace acidic catalyst is coated on the top of arrays of core nanocrystals or drop casting of the sol on the arrays of core/shell spots.

The methods and devices of the present invention are further demonstrated in the attached figures showing representative results and in the examples at the end of this disclosure.

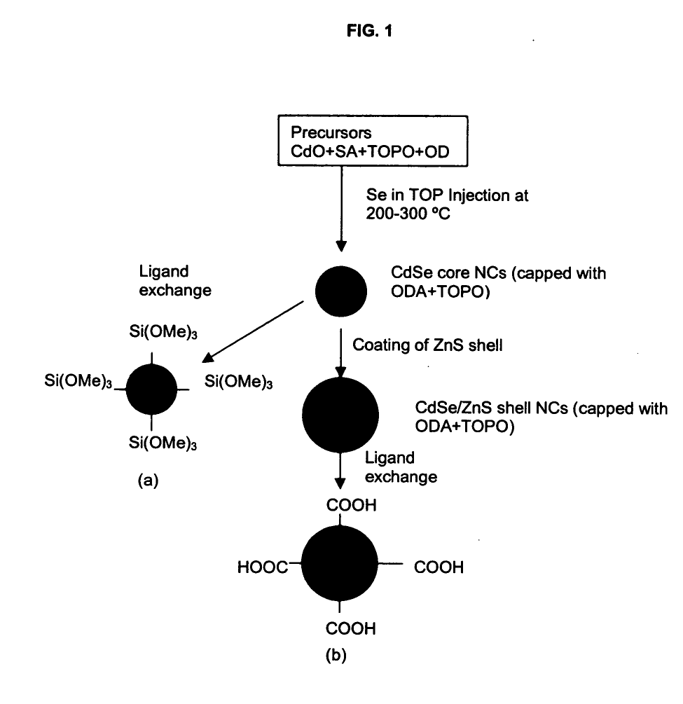

FIG. 1 is a schematic diagram showing a procedure that can be used for synthesis of water-soluble (a) CdSe core and (b) CdSe/ZnS core/shell NCs, respectively. Functional molecules that can be used to modify the surface of the NCs include, but are not limited to, the ligands indicated in the diagram.

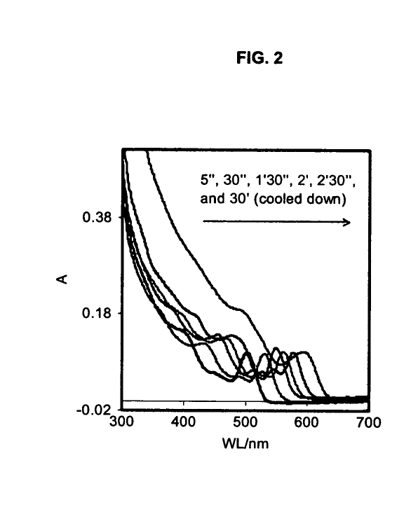

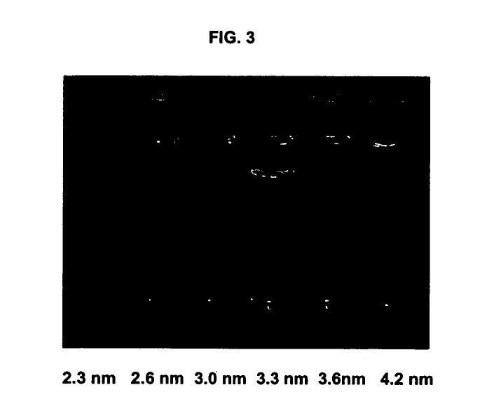

FIG. 2 illustrates the UV-vis spectra of the CdSe NCs growing from small to large size with reaction time. As shown, small NC's have short wavelength absorptions. FIG. 3 shows a photograph of the NCs shown in FIG. 2 under UV irradiation showing the colour change in the fluorescence as the size increases.

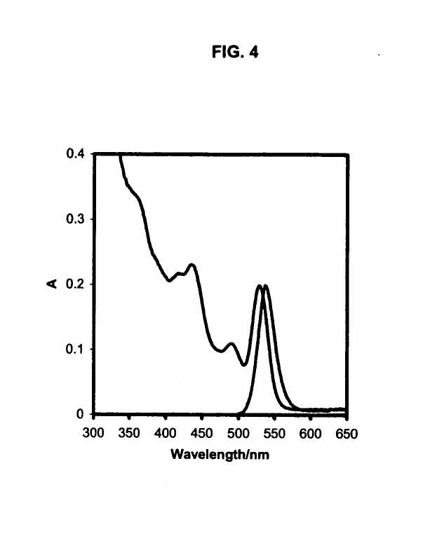

FIG. 4 illustrates the UV-vis and emission spectra of a chloroform solution of CdSe NCs with size of 2.7 nm. The sharp and symmetric profiles of the first transition peak in the UV-vis spectrum and the emission band (the line width of the emission band 27 nm) indicate an essentially monodisperse population of the NCs. The NCs can be used directly for further processing without any size selective precipitation.

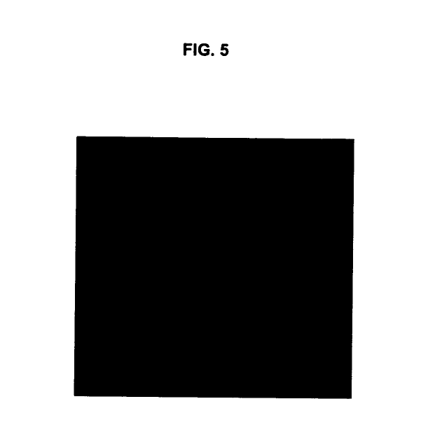

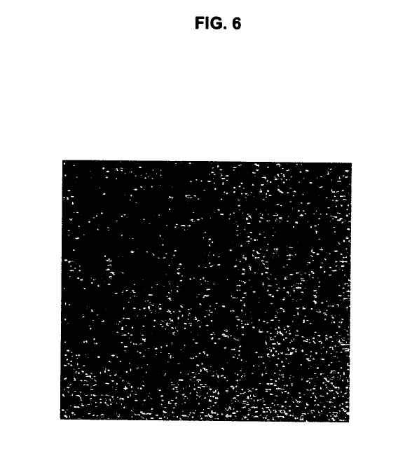

FIG. 5 shows an atomic force microscope image of a cluster of NCs deposited on a mica surface. The individual spherical NC can be seen clearly in the cluster. The crystallinity of the NCs can be seen clearly in the high-resolution TEM image in FIG. 6.

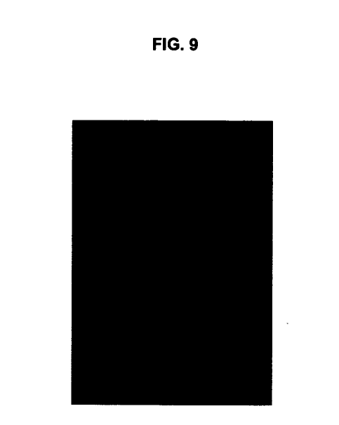

FIG. 7 illustrates the UV-vis spectra of exemplary synthesized CdSe/ZnS core/shell NCs capped with ODA and TOPO molecules, and water-soluble CdSe/ZnS core/shell NCs capped with MSA molecules. FIG. 8 presents fluorescence emission spectra of the NCs shown in FIG. 7. The core/shell NCs capped with ODA show very good monodispersity (emission line width 29 nm) and gives strong fluorescence (quantum yield 45%), similar to conventional organic dyes. After exchange of the surface ligand molecules ODA and TOPO with MSA, the NCs are still highly monodispersed (emission line width 28 nm). The fluorescence quantum yield remains as high as 20%. FIG. 9 shows the gives emission color of the two types of core/shell NCs shown in FIG. 7.

In order to print high quality, highly fluorescent nanocrystal arrays with the properties described above, two major problems had to be addressed. First, it was necessary to impede the tendency of NCs to precipitate during storage due to aggregation of the NCs in concentrated solution. Aggregated NCs block the print head of a standard microarray printer. Secondly, it was necessary to stabilize the surface of the NCs to suppress mid-gap emission.

The synthesis of the core/shell type NCs is more complicated compared with that of the core NCs. Experimental conditions must be precisely controlled to ensure that the layer of ZnS shell grows epitaxially on the surface of the CdSe core, instead of forming new ZnS NCs. The present invention provides a preparation of high quality CdSe/ZnS core/shell NCs with strong photoluminescence (quantum yield 40-90%) and narrow size-distribution (line width of the emission profile 27 to 30 nm, which corresponds to a variance in diameter of 5% or less).

Several factors contribute to achieving a highly consistent nanocrystal array calibration device. The NCs preferably have surface modification that allows them to be soluble in an appropriate solvent. For printing from polar solvents, a carboxylic acid surface coating in preferred. However other coating such as sulfonic acid or any other highly acidic group is suitable. Other groups that promote the solubility in polar solvents without promoting aggregation include highly basic groups such as amino groups that become positively charged at neutral pH. The exchange with the TOP/TOPO ligands from the surface of the core-shell NC (required to make them soluble in polar solvents) requires a group with Lewis base characteristics. Thiols are preferred but other groups such as amino or alcohols are suitable.

For optimal results, the printing solution preferably has the following properties: It should be suitable for use in the printing apparatus, including pin-type microarrayers, ink-jet microarrayers or other robotic based printers/dispensers. The printing solution should be able to dissolve the NCs and prevent aggregation, precipitation or any other surface interaction that would compromise the efficacy of the printing device. The printing solution also should have a medium-high viscosity and or volatility to prevent non-uniform distribution of the NCs in the array element. Preferably, a binary mixture of a high volatility and low-volatility solvent is used. For polar solvents, the volatile components may be water, methanol, ethanol, acetonitrile, 2-methyl-2-propanol or other highly polar solvents with boiling points below 100 C, whereas the non-volatile component may be ethylene glycol, propylene glycol, dimethylsulfoxide, N,N-dimethylformamide or any other high boiling organic solvent. For certain printing instruments a 50-50 mixture (v/v) of water and ethylene glycol was found to work well. For non-polar solvents, the volatile component may be chlorocarbons (e.g. dichloromethane, chloroform, carbon tetrachloride), hydrocarbons (pentane, hexane,), ethers (e.g. tetrahydrofuran, diethyl ether) or other non-polar low boiling solvents. The non-volatile components may be long chain hydrocarbons (decane, dodecane, tetradecane, etc.), aromatic hydrocarbons (e.g. alkylbenzenes, dialkylbenzenes) or other non-polar high molecular weight organic liquids.

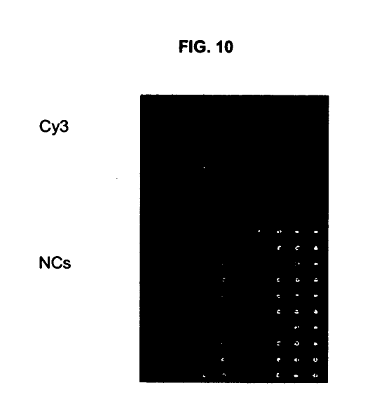

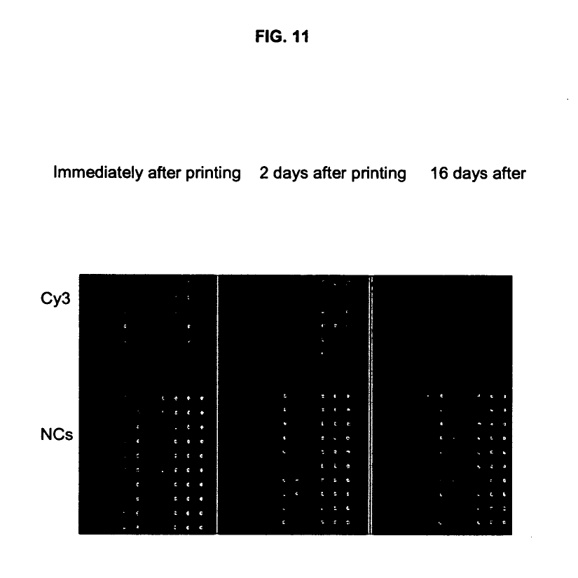

The printing process was found to be highly effective when using an ethylene glycol-water solvent solution. This provides NCs arrays on glass slides with homogenous intensity profiles and very bright emission. An exemplary array is shown in FIG. 10. The present invention provides a novel process that is convenient, economical and safe.

To study the effect of aging on the CdSe/ZnS core/shell NCs arrayed on glass slides, the samples were scanned immediately after printing, 2 days after printing, and 16 days after printing. The results are presented in FIG. 11. It is clearly apparent that the NC deposits of the present invention show excellent stability after being stored at ambient temperature for 16 days compared to the dyes that faded significantly on storage. After 5 months the arrays did not show any significant change compared to images obtained immediately after the printing. Thus the arrays of the present invention comprising monodispersed NCs make ideal calibrants for biological detection with DNA microarrays.

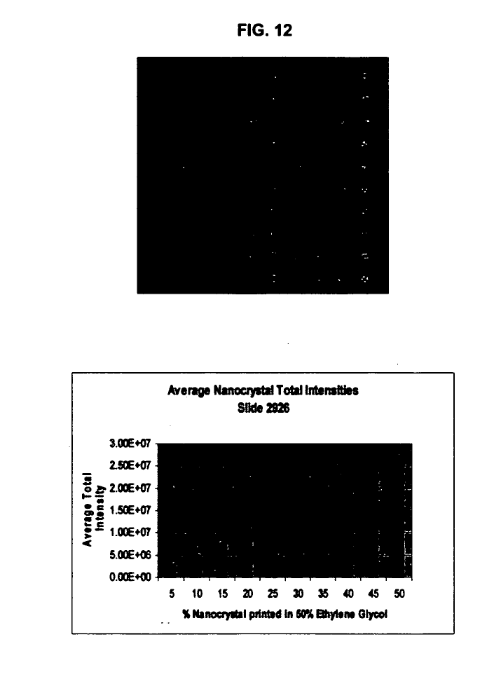

The arrays of the present invention are consistent. As shown in FIG. 12, the dilution series illustrates an increasing scale of highly reproducible NC array elements.

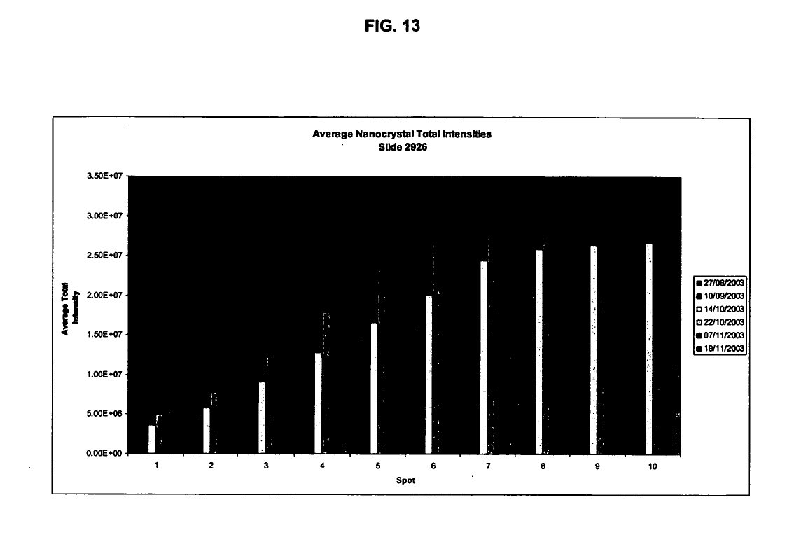

The NC arrays of the present invention are highly stable over time. As illustrated in FIG. 13, changes in the fluorescence intensity were observed after several months of storage. Changes in intensity are instrument fluctuations from week to week. The calibration slide allows measurements to be normalized to provide slide to slide comparisons with a precision of less than 2 percent.

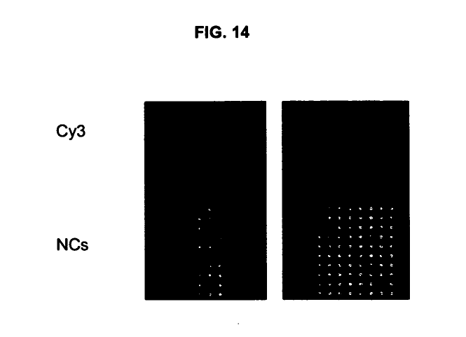

For certain applications, it is desirable to cover the deposited array with a layer of sol-gel. A binding assay can then be performed on the surface of the sol-gel and the array acts as an internal standard. The effect of sol-gel coating on photoluminescence and morphology of the arrays of NCs and Cy3 was investigated. The images in FIG. 14 show that overcoating with a sol-gel film does not result in noticeable decrease in fluorescence and morphology change on array spots for NCs. In contrast, when Cy3 was used, the dye spots became a little bit brighter and smeared after a sol-gel coating was applied. Moreover, both Cy3 and the NCs are invisible in the Cy5 channel after the sol-gel coating. In summary, introduction of an overlayer of the sol-gel film does not have any significant negative effect on the photoluminescence properties of the NC arrays. This represents the basis of a scalable, commercial process for the fabrication of microarray colour/intensity standards. The present invention also provides smart DNA chips in which these calibration and barcoding features are built into each individual microarray.

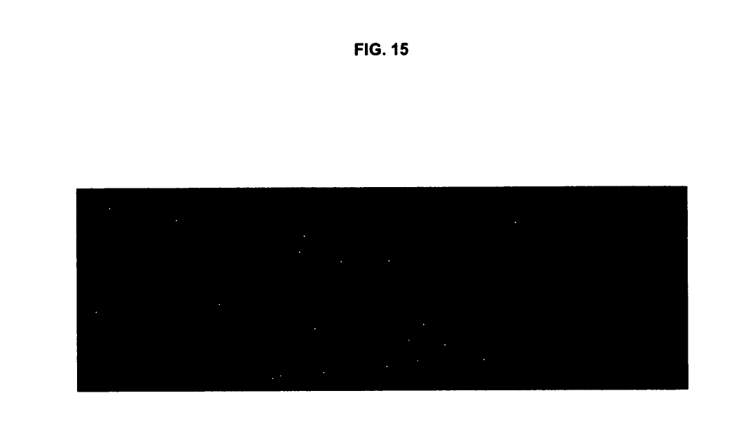

To test the efficacy of having on-chip calibration instead of an external calibration slide, an NC standard array was printed onto a prefabricated DNA microarray. The results are shown in FIG. 15. Using the present invention, it is possible to carry out a hybridization reaction and preserve the NC array for direct, on-slide calibration.

The invention thus provides for the use of arrays of nanocrystals as new calibrants for microarrays. Coating the surface of the arrays with a sol-gel film provides a novel assay surface with integral standards. Such a system may also find applications in other fields such as display devices. The sol-gels have the advantage that they are easily processed and can be cured to form a glass-like matrix, which is chemically identical to the glass slides typically used for biochip microarrays. The chemical functionality and porosity of the sol-gel can be fine tuned allowing limited access of the solvent and biomolecules to the fluorescent calibrants. The hybridization can be performed close to or on the top of the sol-gel film.

In a preferred embodiment of the invention, a microscope slide containing an array of spots of deposited nanocrystals overlaid with a sol-gel film is provided.

The present invention has been described with regard to one or more embodiments. However, it will be apparent to persons skilled in the art that a number of variations and modifications can be made without departing from the scope of the invention as defined in the claims.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

Methods of chemistry, protein biochemistry, immunochemistry and molecular biology used but not explicitly described in this disclosure and these Examples, are amply reported in the scientific literature and are well within the ability of those skilled in the art.

### Example 1

### Preparation of CdSe Core Nanocrystals

Materials. Precursors cadmium oxide (CdO), cadmium acetate, stearic acid, trioctylphosphine oxide (TOPO), octadecylamine (ODA), selenium, trioctylphosphine (TOP), (N-(2-aminoethyl)-11-aminoundecyltrimethoxysilane (AEAUTMS), dimethyl Zinc, hexamethyldisilathiane ((TMS)₂S), mercapto-succinic acid (MSA), ethylene glycol, and tetraethyl orthosilicate (TEOS), etc, were purchased from Adrich and used as received. Chloroform, methanol and other reagents are in analytical grade. Epoxide-terminated glass slides were purchased from Quantifoil, Inc.

Synthesis of CdSe NCs. A selenium stock solution was prepared under an argon atmosphere. The solution was made by mixing 0.08 g of selenium, 2.00 g of trioctylphosphine (TOP), and 0.035 g of anhydrous toluene (99.8%) in a glass vial and sealed with a rubber septum.

4.00 g of TOPO and 0.05 g of cadmium acetate were mixed in a 50 ml 3-necked flask. The mixture was heated to 330° C. under argon flow. At this temperature the selenium solution was quickly injected into the reaction flask in a single step. The reaction temperature was adjusted to 270° C. immediately after the injection. Small aliquots of the reaction solution were taken at 1 min intervals to monitor the reaction progress by measuring UV-vis spectra. The reaction was stopped 5 min after the injection, and the heat was immediately removed. The reaction solution was allowed to cool to about 50° C., and MeOH and acetone were added to precipitate the NCs. The vessel was covered to protect the NCs solution from light and was kept overnight to allow the nanocrystals to settle down. The supernatant was then decanted, and the precipitant was centrifuged to remove remaining solvent. The NCs were stored under dark without drying.

### Example 2

### Preparation of CdSe/ZnS Core/Shell Semiconductors

In a typical synthesis, 0.024 g of CdO and 0.4 g of Stearic acid were loaded into a 50 ml three-necked flask and heated to 200° C. under Ar protection until it becomes colorless. The mixture was then cooled down to room temperature. 3.0 g TOPO and 3.0 g ODA were added to the flask and heated to 300° C. Then a solution of 0.2 g Se in 4 g TOP is injected into the reaction flask rapidly. The temperature was adjusted to 200° C. at which time ZnS precursors 0.40 ml dimethylzinc and 0.07 ml (TMS)₂S in 2 ml TOP were injected slowly into the reaction flask over 5 to 10 min. The reaction mixture was then kept at 100° C. for 3 hrs. The solid NCs can be obtained by precipitating the NCs with addition of methanol. This powder was used to prepare water-soluble NCs.

### Example 3

### Depositing of Arrays

Hydrophilic CdSe NCs were prepared by exchanging of TOPO and ODA molecules by AEAUTMS. Ethanol solution of the water-soluble NCs was used for printing of the NC arrays on glass surface.

Water-soluble NCs were prepared by heating mixture of the core/shell NCs with carboxylic acid-terminated thiols in methanol at 50° C. to 70° C. under protection of Ar. Aqueous solution of the core/shell NCs was used for fabrication of the NC arrays on glass surface.

The NC solutions were deposited on the surface using a standard micro-array printer.

### Example 4

### Calibration of Fluorescent Signal

UV-vis spectra of CdSe/ZnS core/shell NCs in solution were taken with a Varian Cary 300 spectrophotometer. Fluorescence spectra were taken with PTI Xe flash steady state spectrofluorometer. Arrays of the NCs and Cy3 were prepared by using Affymetrix 417 Arrayer. Confocal imaging of the arrays was performed with a Packard (GSI Lumonics) Microarray Chip Reader.

### Example 5

### Sol-Gel Overlay

Sols with various components were tested under different conditions as a means to protect the arrayed NCs from physical damage due to handling. Typically, a sol was prepared by mixing of TEOS, H₂O, ethanol, and acetic acid in certain molar ratio in a glass vial. The sol was sealed in the glass vial and left for hydrolysis and condensation at room temperature for several days. The final sol was then spin coated or drop cast by a pipette on glass slides preprinted with arrays of Cy3 and the NCs (Cy3 was used for comparison to demonstrate the interchangeability of the dye and the NC for the purpose of fluorescence analysis).

What is claimed is:

1. A calibration device for a fluorescence detector, said device comprising at least one deposit of essentially uniformly deposited nanocrystals.

2. A calibration device according to claim 1, wherein the deposited nanocrystals form a spot having a diameter from about 1 to 1000 microns.

3. A calibration device according to claim 2 wherein the spot has a diameter from about 10 to 500 microns.

4. A calibration device according to claim 1, wherein the deposit comprises at least one nanocrystal having a core selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN) and the like including mixtures of such materials.

5. A calibration device according to claim 4, wherein the nanocrystal further comprises a shell of a material other than that of the core wherein the shell material is selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN), mixtures thereof and the like.

6. A calibration device according to claim 1 wherein the nanocrystal is hydrophilic.

7. A calibration device according to claim 2 wherein the nanocrystal comprises a CdSe core.

8. A calibration device according to claim 3 wherein the nanocrystal comprises a ZnS shell.

9. A calibration device according to claim 1, wherein the nanocrystals are functionalized to be soluble in a polar solvent.

10. A calibration device according to claim 1, wherein the device comprises a plurality of deposits in the form of spots.

11. A calibration device according to claim 10 wherein the nanocrystals vary in size or number from one deposit to another.

12. A calibration device according to claim 11 comprising a series of spots wherein the number of deposited nanocrystals increases throughout the series of spots.

13. A calibration device according to claim 1 wherein the deposit of nanocrystals is overlaid with a sol-gel film.

14. A process for preparing a layer of nanocrystals, said process comprising:
i. preparing a solution of nanocrystals in a polar solvent;
ii. depositing the solution on a surface; and
iii. coating the surface with a sol-gel film.

15. A process according to claim 14, wherein the nanocrystal comprises a core selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN) and the like including mixtures of such materials.

16. A process according to claim 15 wherein the nanocrystal further comprises a shell of a material other than that of the core wherein the shell material is selected from the group consisting of cadmium sulfide (CdS), cadmium selenide (CdSe), cadmium telluride (CdTe), zinc sulfide (ZnS), zinc selenide (ZnSe), zinc telluride (ZnTe), mercury sulfide (HgS), mercury selenide (HgSe), mercury telluride (HgTe), aluminum nitride (AlN), aluminum sulfide (AlS), aluminum phosphide (AlP), aluminum arsenide (AlAs), aluminum antimonide (AlSb), lead sulfide (PbS), lead selenide (PbSe), lead telluride (PbTe), gallium arsenide (GaAs), gallium nitride (GaN), gallium phosphide (GaP), gallium antimonide (GaSb), indium arsenide (InAs), indium nitride (InN), indium phosphide (InP), indium antimonide (InSb), thallium arsenide (TlAs), thallium nitride (TlN), thallium phosphide (TlP), thallium antimonide (TlSb), zinc cadmium selenide (ZnCdSe), indium gallium nitride (InGaN), indium gallium arsenide (InGaAs), indium gallium phosphide (InGaP), aluminum indium nitride (AlInN), indium aluminum phosphide (InAlP), indium aluminum arsenide (InAlAs), aluminum gallium arsenide (AlGaAs), aluminum gallium phosphide (AlGaP), aluminum indium gallium arsenide (AlInGaAs), aluminum indium gallium nitride (AlInGaN), mixtures thereof and the like.

17. A process according to claim 14 wherein the nanocrystal is hydrophilic.

18. A process according to claim 15 wherein the nanocrystal comprises a CdSe core.

19. A process according to claim 16 wherein the nanocrystal comprises a ZnS shell.

20. A process according to claim 14 wherein the nanocrystal comprises a core of a metallic material wherein the metallic material is selected from the group consisting of gold (Au), silver (Ag), cobalt (Co), iron (Fe), nickel (Ni), copper (Cu), manganese (Mn), alloys thereof and alloy combinations.

21. A process according to claim 14 wherein the polar solvent is selected from the group consisting of ethanol, methanol, propanol, butanol, glycol, ether, polyol, polyether, mixtures thereof and the like.

22. A process according to claim 21 wherein the solvent is ethylene glycol.

23. A process according to claim 14 wherein the sol-gel film comprises tetraethyl orthosilicate.

24. A surface comprising at least one region of dispersed nanocrystals coated with a sol-gel film.

25. A microscope slide comprising a surface as defined in claim 24.

26. A microscope slide according to claim 25 comprising a plurality of regions of nanocrystals, wherein the density of nanocrystals varies from region to region.

27. A microscope slide according to claim 26 comprising at least two different types of nanocrystals.

28. A DNA chip comprising a nanocrystal array calibration barcoding.

29. A method of quantifying a binding reaction comprising:
i) providing an array of an immobilized ligand on the surface of a slide;
ii) contacting the array with a sample;
iii) detecting binding of the sample to the ligand using a nanocrystal detector;
iv) comparing the signal obtained by binding of the sample to the signal generated by a series of spots, each spot comprising a predetermined standardized homogenous dispersion of nanocrystals; and
v) determining the extent of binding based on the number of nanocrystals bound to the sample spot as compared to a standardized spot.
